(19) United States
(12) Patent Application Publication
(10) Pub. No.: US 2017/0197866 A1
(43) Pub. Date: Jul. 13, 2017

(54) Method of processing a panel of multilayer tempered glass and article obtained by said method

(71) Applicant: Andrea Cingoli, Roseto Degli Abruzzi (IT)

(72) Inventor: Andrea Cingoli, Roseto Degli Abruzzi (IT)

(21) Appl. No.: 14/994,275

(22) Filed: Jan. 13, 2016

(51) Int. Cl. C03B 23/023; C03C 17/32; C03B 33/07

(52) U.S. Cl. CPC C03B 23/023; C03B 33/078; C03C 17/326; C03C 2218/112; B32B 17/10761

(57) ABSTRACT

Method of processing a panel of multilayer tempered glass comprising the steps of:
providing a panel of multilayer tempered glass having at least a first and a second plate of tempered glass and an intermediate layer of bonding material interposed between the first and the second sheet of glass to make firmly join together the first and the second glass plate;
breaking the first and the second plate of tempered glass so that the panel can be bent;
bending the panel until reaching a desired shape in which both said first plate and said second plate are bent;
applying to said first plate and to said second plate a hardening substance adapted to stabilize the panel into said desired shape.

### FIELD OF INVENTION

The present disclosure refers to the technical field of processing methods of multi-layer glass and in particular concerns a method of processing a panel of multilayer tempered glass and a multilayer article obtained by said method.

### STATE OF THE ART

A panel of multi-layer tempered glass (or laminate panel) generally comprises two tempered glass plates and an intermediate layer of bonding material interposed between the two plates of glass to make said plates integral to each other. In the panel of multilayer tempered glass more panels of tempered glass may be also provided, providing between each pair of tempered glass plates with an intermediate layer of bonding material.

A panel of multilayer tempered glass is generally made by joining at least two tempered glass plates with a plastic sheet, for example a transparent plastic sheet (for example, a colorless plastic sheet), usually polyvinylbutyral (PVB), which therefore represents the intermediate layer of binding material. The PVB is sandwiched between the two plates of tempered glass and the assembly is thereafter heated to a temperature of 70° C. and pressed with rollers to expel the air and join the materials among them. This operation is terminated by inserting the assembly in an autoclave at constant temperature and pressure, where the ejection process of the air is completed, thus making the panel of tempered glass again transparent.

Once the multilayer tempered glass panel is made, it is practically impossible to change its shape substantially, for example, the panel you cannot be bent in order to give the panel a desired shape. Indeed, currently only a few hot working techniques are known, that allow to change only slightly the curvature of the panel through the application of pressure forces at a given temperature at which plastic deformations of the tempered glass plates can take place.

In addition, if a panel of multilayer tempered glass is defective or damaged or needs to be discarded, this cannot be reused and disposal of the panel is very expensive from the energetic or environmental point of view.

### PURPOSE OF THE INVENTION

One object of the present invention is to provide a processing method of a multilayer tempered glass that it is not affected by the drawbacks of the prior art described above and in particular that allows to modify at will the shape of a panel of multilayer tempered glass; for example, and without thereby introducing any limitation, to provide the ability to reuse multilayer glass panels defective or damaged or discontinued for the creation of new objects, for example architectural elements, furnishing, design, partitions, etc. thus avoiding subjecting them to expensive disposal processes.

### SUMMARY OF THE INVENTION

The above object is achieved in general by a method of processing a panel of multilayer tempered glass comprising the steps of:
providing a panel of multilayer tempered glass having at least a first and a second plate of tempered glass and an intermediate layer of bonding material interposed between the first plate and the second plate for joining said plates each to other;
breaking the first and the second plate of tempered glass so that the panel can be bent;
bend the panel up to the achievement of a desired shape, in which both the first and the second plates of tempered glass are bent;
applying the first and the second plate a hardening substance adapted to stabilize the panel into the desired shape.

According to an embodiment, the step of breaking the first and the second glass plates comprises a step of fragmenting at least a portion of the first plate of tempered glass and at least a corresponding portion of the second plate of tempered glass. In an embodiment, currently representing the best way to carry out the process, in the breaking step the first plate and the second plate of tempered glass are entirely fragmented in a substantially uniform manner.

According to an embodiment, the hardening substance is a resin, for example a two-component resin, e.g. an epoxy resin.

Other preferred and advantageous embodiments of the above explained processing method will be disclosed in the following description of detailed embodiments of the same. In particular, the invention will be better understood from the following detailed description of some of its particular embodiments given by way of example and therefore in no way limitative, with reference to the accompanying figures briefly described in the next paragraph.

### BRIEF DESCRIPTION OF DRAWINGS

FIG. 1 shows a schematic side view of an embodiment of a panel of multilayer tempered glass.

FIG. 2 shows a plan view in front elevation of the panel of multilayer tempered glass of FIG. 1.

FIG. 3 shows a plan view in front elevation of the panel of FIGS. 1 and 2 after a breaking step of the processing method which has been performed only on some regions of the panel.

FIG. 4 shows a front elevation plan view of the panel of FIGS. 1 and 2 after a breaking step of the processing method which has been performed by entirely breaking the glass plates of the panel.

FIG. 5 shows a schematic side view of the multi-layer glass panel of FIGS. 1, 2, 3 during a bending step of the processing method.

FIG. 6 shows a schematic side view of an article obtained from the panel of FIGS. 1, 2 and 3 after the bending step of FIG. 5.

FIG. 7 shows a real photo of an example of an article obtained from a multilayer glass panel using the disclosed processing method.

FIG. 8 is a schematic flow diagram of an embodiment of the method of processing a panel of multilayer tempered glass.

### DETAILED DESCRIPTION

With reference to the accompanying drawings, reference number 1 denotes a panel of multilayer tempered glass (otherwise referred to as laminated panel of tempered glass) comprising at least two tempered glass plates 2,3 and an intermediate layer 4 of bonding material interposed between the two sheets of glass 2,3 to firmly join said plates 2,3. They may be provided more panels of tempered glass, providing between each pair of glass plates an intermediate layer 4 of binding material.

The intermediate layer 4 is, for example, a transparent plastic sheet (for example, a colorless sheet). For example, the intermediate layer 4 is a sheet made of polyvinyl butyral (PVB), but clearly other suitable materials can be used.

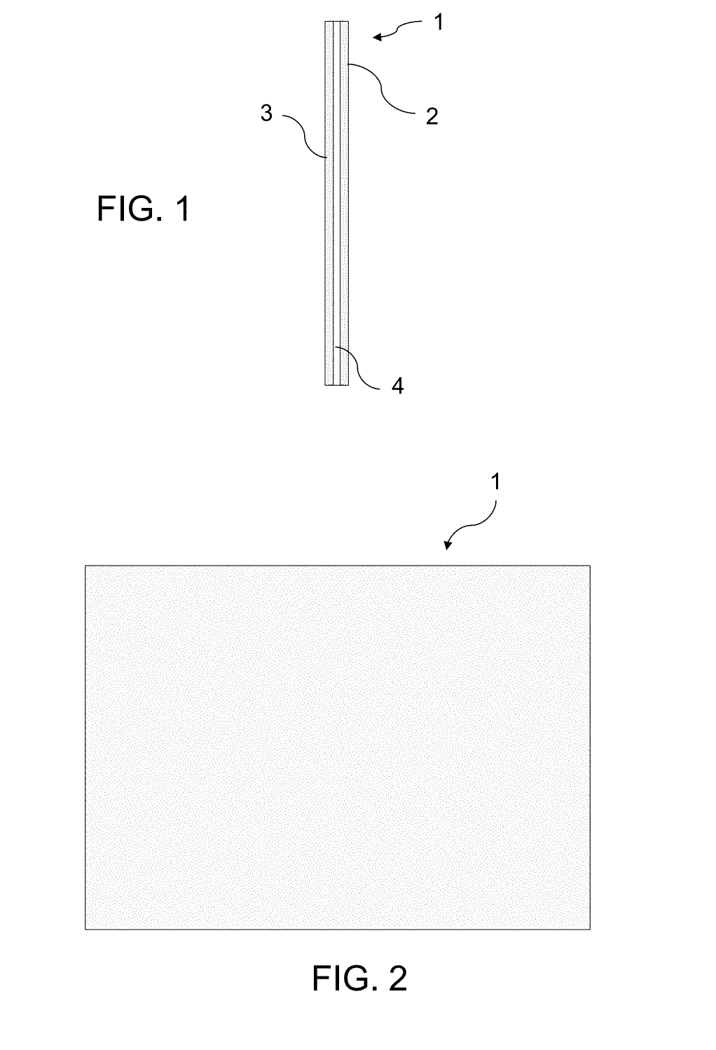

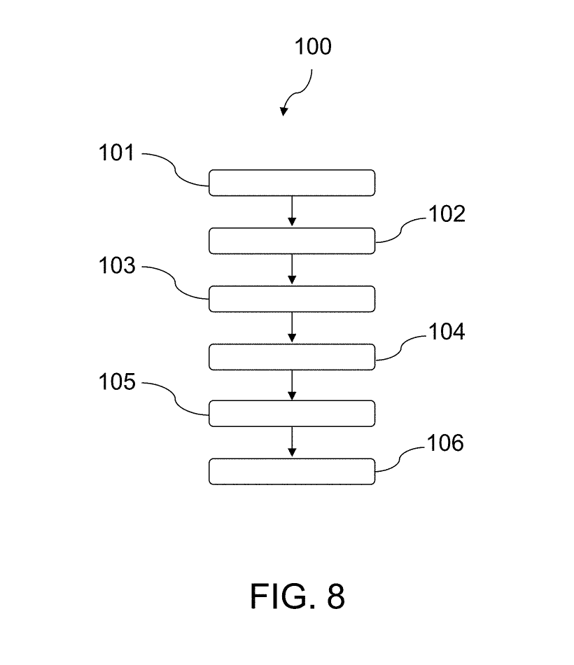

With reference to FIG. 8 and to FIG. 1 the method 100 of processing a multi-layer tempered glass panel 1 includes a step 101 of providing a panel of multilayer tempered glass 1 having at least a first 2 and a second plate 3 of tempered glass and an intermediate layer 4 of binding material interposed between the first 2 and the second glass plate 3 to join together the first and the second plate. In the providing step 101 it is possible to foresee to block the panel 1 to a support structure so as to hold it in place during the subsequent step 102 which will be described below.

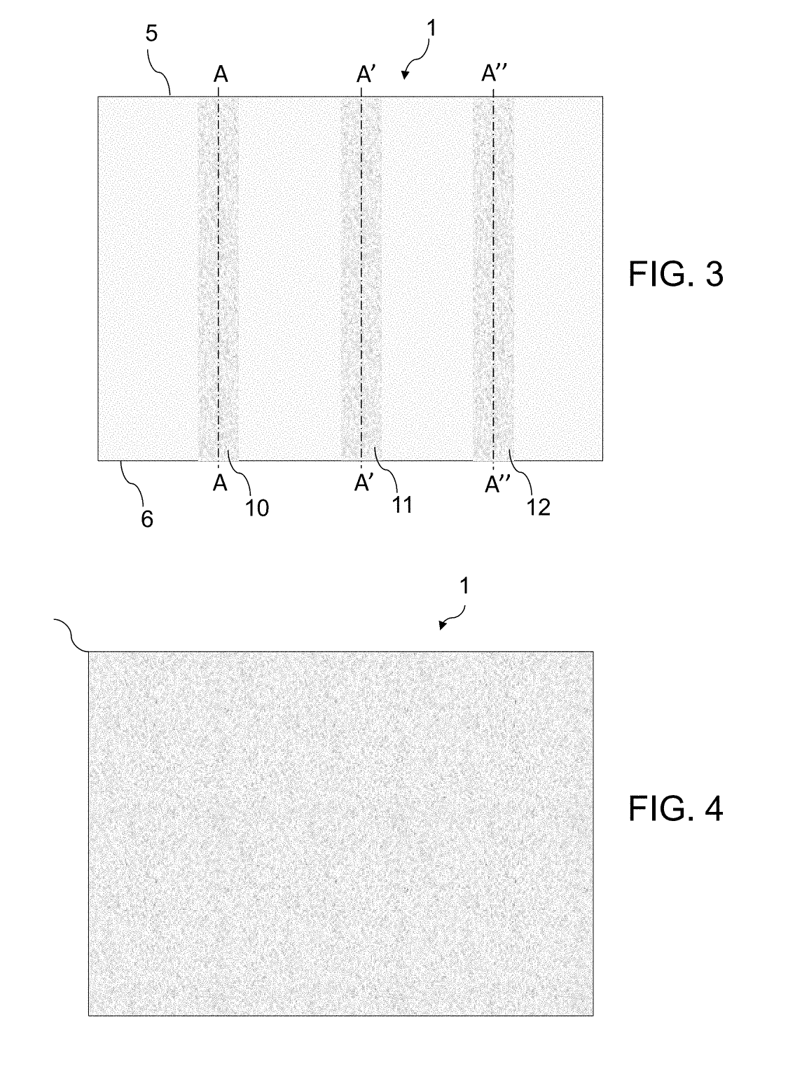

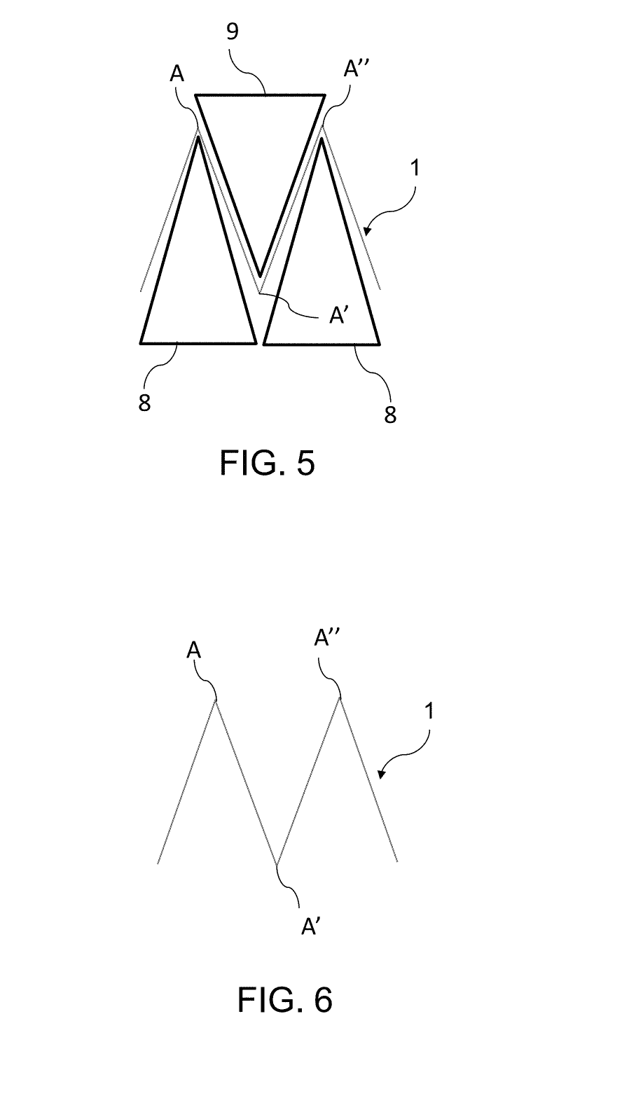

The method 100 further comprises a step 102 of breaking the first 2 and second 3 plate of tempered glass so that the panel 1 can be bent. For example, the breaking step 102 is performed by one or more hammers, hand-operated or forming part of an automatic or semi-automatic machine. According to an embodiment, the breaking step 102 comprises a step of fragmenting at least a portion of the first plate of tempered glass 2 and at least a corresponding portion of the second plate of tempered glass 3. Preferably, for example as shown in FIG. 3, said first portion and said second portion are portions that extend from a first edge 5 of the panel 1 to a second edge 6 of the panel 1 so that the panel 1 can be folded along a line A-A, A′-A′, A″-A″ which extends between the first edge 5 and the second edge 6. In FIG. 3, in the breaking step the panel 1 was fragmented along three regions 10,11,12 (and was not fragmented in its remaining parts) extending from the first edge 5 to the second edge 6 of the panel 1. That implies that both the first and the second sheet were fragmented along said regions. In this way, the panel 1 can be bent along three lines A-A, A′-A′, A″-A″.

According to an embodiment the breaking step 102 comprises a step of entirely fragmenting the first 2 and the second glass plate 3, preferably in glass particles having substantially uniform size. FIG. 4 shows a panel 1 in which, starting from a panel 1 as shown in FIGS. 1 and 2 through the breaking step, the first and the second grass plates are entirely fragmented, in other words the panel 1 was fragmented throughout the respective area of the plates. This can be for example obtained by imparting to each of the two tempered glass plates a shot, for example using a hammer, which impacts on an edge angle of the plates perpendicular to the lying plane of the plates.

According to an embodiment, at the end of the aforementioned breaking step 102, each of the first 2 and the second plate 3 of glass comprise a plurality of glass particles having substantially uniform sizes among them and that adhere to the intermediate layer 4. For the purpose of present description, glass particles of uniform size means particles that have a volume such that the volume of a particle is on average at most equal to four times the volume of another particle, preferably on average at most equal to two times the volume of another particle, more preferably on average equal, or approximately equal, to that of another particle.

The processing method 100 further comprises a step 103 of bending the panel 1 until it reaches a desired shape in which both the first glass plate 2 and the second glass plate 3 are bent. According to an embodiment, through the above described steps it is possible to provide a panel 1 at least partially fragmented and that at the fragmented portions 10, 11, 12 thereof turns out to be bendable or bent. Preferably, through the above disclosed steps a panel with in which the plates 2,3 are entirely fragmented is obtained, for said reason the panel being bendable or bent.

The bending step 103 may be performed manually with the adoption of gloves, or may be performed automatically or semi-automatically by means of machinery or tools. According to an embodiment, in the bending step 103 at least a support and abutment element is employed, for example with reference to FIG. 4, to bend a panel such as the panel of FIG. 3 one or more templates 8 and/or ribs and/or formworks can be used. Again with reference to FIG. 4, according to one embodiment in the bending step 103 it is also possible to employ one or more elements or tools 9 for the application of a pressure force. In FIG. 4 the bending regions have been represented for simplicity as cusps, because the panel has been bent along the lines A, A′,A″ so that the panel 1 is bent in a zigzag shape, but it is also possible to bend the panel according to curved shapes according to a desired degree of curvature so as to obtain a bent panel having a C-shape, an S-shape, a wave shape, etc. If the panel 1 is entirely fragmented the panel can be shaped as desired, for example by placing it on an abutment shaped surface so that the panel is counter-shaped with respect to the shaped surface. It is clear that, after the steps of breaking and bending, the first plate 2 and the second plate 3 cannot be defined more properly as “plates”, because they lose the flat shape due to the bending step or the continuity due to the breaking step, however, in the present description for sake of simplicity the term “plate” is used also after the breaking step 102 and the bending step 103, which in this particular meaning therefore means also “modified plate”, or “bent plate”, or “broken and bent plate”.

According to an embodiment, the bending step 105 is performed as a cold processing step, for example at room temperature. According to an advantageous embodiment, the bending step 105 is carried out without heating the tempered glass plates 2,3 or generally without bringing them to a temperature such that these can undergo a plastic deformation of the glass.

According to an embodiment, it is possible that in the above described breaking step 102 or breaking step 103, glass fragments or particles may detach from the intermediate layer 4 and thus create some interstices between neighboring glass particles or fragments. For this reason, the method 100 comprises after the step of breaking and/or after the step of bending a step of removing 104 the glass fragments, for example by means of a suction operation and/or a spraying operation of a liquid substance, such example of water, or in general of a fluid such as pressurized air or water. If there is provided a spraying operation with a liquid substance, it is possible to provide a subsequent drying operation, for example by subjecting the panel 1 to a forced flow of air.

The method 100 also comprises a step of applying 105 to both the first 2 and second plate 3 a hardening substance adapted to stabilize the panel 1 into the desired shape. Preferably, the hardening substance is such as to be able to fill any interstices between the particles or pieces of glass. Preferably the step of applying includes a step of applying more layers of the hardening substance, for example at least three layers, preferably at least five layers, for example seven layers. If more layers are applied, for example by brushing or spraying, after application of a layer it is appropriate to reach the hardening state of said layer before applying a further layer.

In the case of multi-layer application, after having applied a layer of hardening substance it is possible to apply a layer of a filling substance such as silicone-based filler in order to fill any cracks and interstices and then subsequently applying another layer of hardening substance on the filling substance, so as to obtain a final surface that is as smooth as possible.

According to an embodiment, the step of applying is carried out by applying 105 said hardening substance by brushing or by spraying. Said hardening substance is for example in liquid form or in gel form and is suitable to harden over time. Said hardening substance is preferably a two-component resin, preferably a transparent resin, more preferably a colorless resin. Said resin is for example an epoxy resin. The step of applying 105 can be performed simultaneously on the two modified plates or, alternatively, first on a modified plate and subsequently, after the hardening of the substance, on the second modified plate.

According to an embodiment, after the step of applying 105, a step of consolidating the hardening substance may be provided, for example by subjecting the panel to a forced flow of air or by leaving for a certain time the panel in a closed environment.

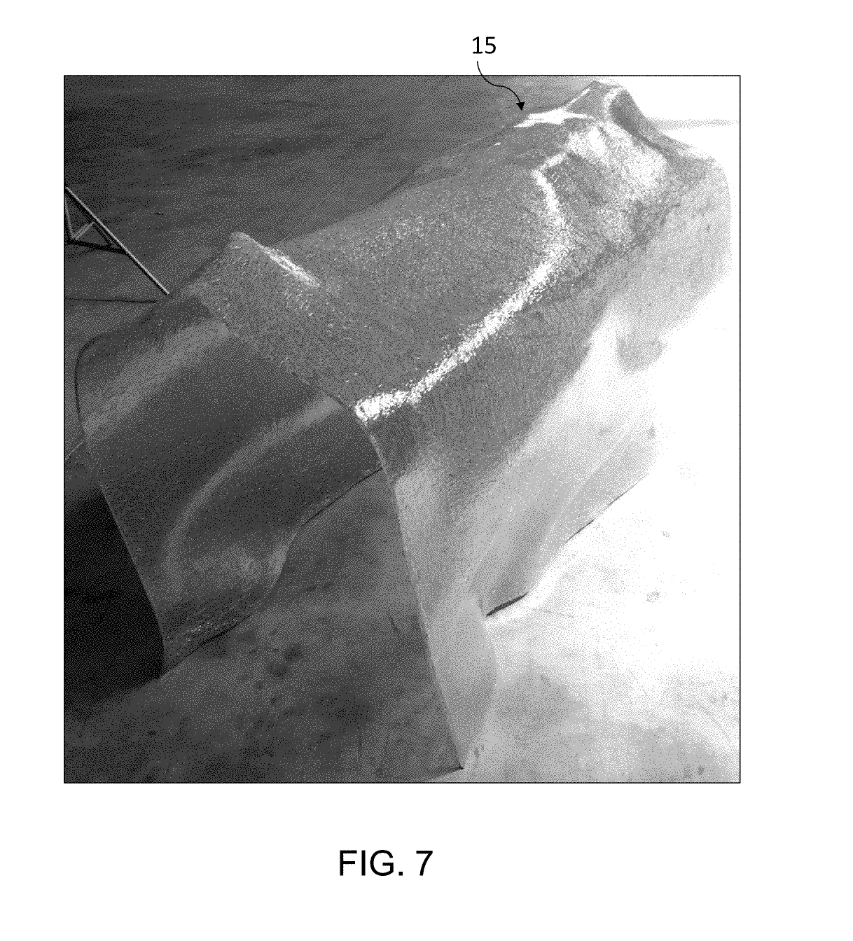

With reference to FIG. 7, there is shown an example of an article 15 obtained by the above described processing method. In particular, without thereby introducing any limitation, to obtain the article 15 the following steps were performed: a panel of multilayer tempered glass was subjected to the breaking step 102 in its entirety, then after the bending step 103 the panel was placed on of an anthropomorphic dummy, and subsequently a hardening substance was applied to the bent panel, first on the upper face of the panel and after on the lower face.

As it is clear from the above description, the processing method described above allows to achieve fully the intended purposes in terms of overcoming the drawbacks of the known art. In fact, using the above method it is possible to freely change the shape of a panel of multilayer tempered glass to create articles of furniture, architectural, design items, outdoor furniture and gardens, partitions, roof elements, screens, etc.

It will be appreciated that this processing method has also environmental advantages since it allows recycling panels defective, damaged or in kind that must be disposed of by the use, think for example the enormous amount of panels to be disposed in the remake of glass building facades.

The innovative method proposed allows to modify the shape of the glass sheets of the panel in a condition of low temperature (without the aid of ovens) subsequently blocking the shape configuration reached so as to obtain glassy elements curved and resistant.

The method described allows to obtain a new material with different performance and features (compared to the starting panel of multilayer tempered) suitable for use in art (sculptures), building and construction (cladding, partitions, furniture and interior elements coverage), and design (objects and lamps).

The method described contributes to environmental protection and for the fact of being able to use raw materials from wastes or disposal both for reduced energy consumption; the production cycle also is particularly economical because it requires the use of minimal equipment (jigs/molds, brushes, gloves) and reduced operating spaces. However it should be noted that the above processing method is also applicable to panels of multilayer tempered glass which are not intended to be recycled.

It is also important to observe that the glass panels can be panels of colorless glass or colored glass panels, opaque or transparent, e.g. colored partially or entirely colored. Also the hardening substance may have colored pigments, for example having a color similar or equal to that of the glass panels.

Without prejudice to the principle of the invention, the forms of embodiment and details of construction can be widely varied with respect to what has been described and illustrated purely by way of non-limiting example, without thereby departing from the scope of the invention as defined in the appended claims.

1. A method of processing a panel of multilayer tempered glass comprising the steps of:
providing a panel of multilayer tempered glass having at least a first and a second plate of tempered glass and an intermediate layer of bonding material interposed between the first and the second sheet of glass to make firmly join together the first and the second glass plate;
breaking the first and the second plate of tempered glass so that the panel can be bent;
bending the panel until reaching a desired shape in which both said first plate and said second plate are bent;
applying to said first plate and to said second plate a hardening substance adapted to stabilize the panel into said desired shape.

2. A method according to claim 1, wherein the breaking step comprises a step of fragmenting at least a portion of the first plate and at least a corresponding portion of the second plate.

3. A method according to claim 1, wherein the breaking step comprises a step of entirely fragmenting the first and the second glass plate.

4. The method according to claim 3, wherein said step of entirely fragmenting the first and the second tempered glass plate is such as to fragment said plates into glass particles of substantially uniform size.

5. The method according to claim 1, wherein the end of said breaking step each of the first and of the second plate of glass comprise a plurality of glass particles of substantially uniform size attached on the intermediate layer.

6. The method according to claim 1, wherein said hardening substance comprises a resin.

7. A method according to claim 6, wherein said resin is an epoxy resin.

8. A method according to claim 1, wherein said step of applying comprises a step of brushing the bent panel with said hardening substance.

9. A method according to claim 8, wherein said step of applying comprises an operation of applying with a brush a plurality of layers of said hardening substance.

10. A method according to claim 1, wherein said step of applying comprises an operation of spraying said hardening substance on said bent panel.

11. A method according to claim 10, wherein said step of applying comprises an operation of spraying a plurality of layers of said hardening substance.

12. A method according to claim 1, wherein the step of bending is performed at room temperature.

13. A method according to claim 1, wherein said step of bending is carried out without heating the glass sheets or in gender without bringing them to a temperature at which these can undergo a plastic deformation of the glass.

14. Article obtained through a processing method in accordance with any one of the preceding claims.
